(19) United States
(12) Patent Application Publication
(10) Pub. No.: US 2018/0246789 A1
(43) Pub. Date: Aug. 30, 2018

(54) INFORMATION PROCESSING APPARATUS AND INFORMATION PROCESSING METHOD

(71) Applicants: KABUSHIKI KAISHA TOSHIBA, Tokyo (JP); TOSHIBA TEC KABUSHIKI KAISHA, Tokyo (JP)

(72) Inventor: Masaru KOGA, Mishima Shizuoka (JP)

(21) Appl. No.: 15/442,138

(22) Filed: Feb. 24, 2017

(51) Int. Cl. G06F 11/16; G06F 11/22; G06F 11/20; H04N 1/21; H04N 1/00

(52) U.S. Cl. CPC G06F 11/1666; G06F 11/2205; G06F 11/2017; H04N 2201/0081; H04N 1/00029; H04N 1/00074; H04N 2201/0082; H04N 1/2166

(57) ABSTRACT

An information processing apparatus described herein includes a hard disk drive device and a controller. The controller is configured to carry out a self-diagnostic test regarding the operation states of the hard disk drive device, output result information of the self-diagnostic test, acquire failure determination information of the hard disk drive device which is different from the result information, and determine whether it is time to replace the hard disk drive device based on the failure determination information and the result information of the self-diagnostic test.

### FIELD

Embodiments described herein relate generally to an information processing apparatus and an information processing method.

### BACKGROUND

An image forming apparatus is an apparatus for forming an image through electrophotography. In this image forming apparatus, a large amount of data is processed, and a high-capacity disk-type storage device (Hard Disk Drive: HDD) is used in most cases. However, it is known that the HDD often breaks down suddenly. Thus, various methods are used to predict HDD failures in advance and avoid unplanned outages. These methods include, for example, a method using S.M.A.R.T. (hereinafter, referred to as SMART) information and a method using a self-diagnostic test. However, actually, an operator determines whether or not it is time to replace the HDD by observing a variety of data relating to the breakdown.

### DESCRIPTION OF THE DRAWINGS

The accompanying drawings, which are incorporated in and constitute a part of this specification, illustrate an embodiment of the invention and together with the description, serve to explain the principles thereof.

FIG. 1 is a schematic configuration diagram of an image forming apparatus according to the present embodiment;

FIG. 2 illustrates an example of the configuration of a data storage section in the image forming apparatus of the present embodiment shown in FIG. 1;

FIG. 3 illustrates an example of the configuration of a hard disk drive control device in the data storage section shown in FIG. 2;

FIG. 4 is a logical table indicating whether it is replacement time of an HDD or the HDD executes backup from a self-diagnostic test result signal and four failure prediction signals of the embodiment.

FIG. 5 is a diagram illustrating a flowchart for carrying out logic realization shown in FIG. 4;

FIG. 6 is a diagram illustrating the system in a case of sending an HDD replacement signal obtained in the image forming apparatus of the embodiment to an external device.

### DETAILED DESCRIPTION

According to an embodiment, an information processing apparatus includes a hard disk drive device and a controller. The controller is configured to carryout a self-diagnostic test regarding the operation states of the hard disk drive device, output result information of the self-diagnostic test, acquire failure determination information of the hard disk drive device which is different from the result information, and determine whether it is time to replace the hard disk drive device based on the failure determination information and the result information of the self-diagnostic test.

Reference will now be made in detail to the present embodiment of the invention, an example of which is illustrated in the accompanying drawing.

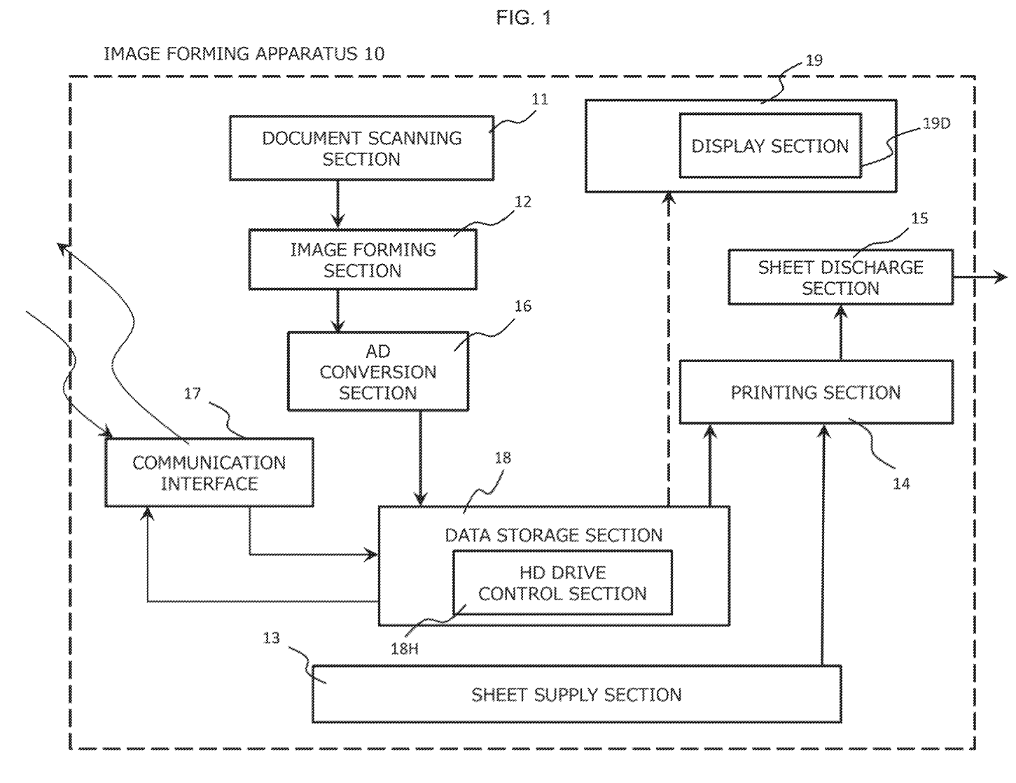

Hereinafter, an embodiment is described with reference to the accompanying drawings. The embodiment is an example of an image forming apparatus. FIG. 1 is a schematic configuration diagram of an image forming apparatus 10 according to the present embodiment.

The image forming apparatus 10 includes a document scanning section 11 which is arranged at the upper part of the image forming apparatus 10 and serves to scan a document, an image forming section 12 which forms a latent image of the document on the basis of a document scanning signal obtained by the document scanning section 11 and forms a visible image from the latent image, a sheet supply section 13 which supplies a sheet to be printed, a printing section 14 which prints the visible image on the sheet, a sheet discharge section 15 which discharges the printed sheet, an AD conversion section 16 which converts an analog signal of an image obtained from the image forming section 12 to a digital signal, a communication interface section 17 which sends and receives a digital signal through wireless communication with an external device, a data storage section 18 which stores a digital signal received through the communication interface section 17 and a digital signal converted by the AD conversion section 16, and an operation panel 19 which controls the digital signal in the data storage section 18 and states in the data storage section 18. The operation panel 19 is a touch panel and includes a display section 19D.

The data storage section 18 includes a hard disk drive control device 18H. It is also possible that data stored in the data storage section 18 is sent to an external communication device via the communication interface section 17.

The document scanning section 11 and the operation panel 19 are arranged at the upper part of the image forming apparatus 10. The document scanning section 11 includes, for example, a document table for document placement which is formed by a transparent material such as a glass plate, a document is placed on the document table and scanning of the document is started.

The operation panel 19 is arranged at the side of the document scanning section 11. The operation panel 19 displays the state of the image forming apparatus 10 on the display section 19D and is constituted by, for example, a touch panel so that an operator may touch and thereby select one of choices displayed thereon, or can input a variety of data. Further, the operation panel 19 is arranged in such a manner that a user can change a direction of a display surface of the display section 19D by operating the operation panel 19.

An ADF (Auto Document Feeder) (not shown) for continuously conveying documents and a scanner are arranged in the document scanning section 11 which can cover the document table. A scanner for optically reading the image of a document placed on the document table is arranged at the lower surface side of the document table.

The image forming section 12 first obtains optical light reflected from a document in the document scanning section 11 and forms a latent image corresponding to the reflected light. The image forming section 12 is roughly composed of a part which forms an electrostatic latent image on an image carrier from signals obtained from the scanner and the reflected light, and a part for changing the electrostatic latent image into a visible image using toner.

The scanner includes, for example, a carriage equipped with a light source which emits light to the document table, a reflection mirror for reflecting the light of the light source to the document, a lens block for magnifying the reflected light, and a CCD (Charge Coupled Device). The carriage is arranged along the lower surface of the document table in a reciprocating manner.

The light source on the carriage is illuminated, and the carriage reciprocates to illuminate the surface of a document placed on the document table. The light reflected from the document is received by the CCD via the reflection mirror and the lens block for magnification. In a case of obtaining a color signal, it is necessary to split the light, and for example, three reflection mirrors are used.

The CCD outputs a digitized image signal corresponding to a reflected light image of the document to an image processing circuit. After image processing is suitably performed on this image signal by the image processing circuit, the image signal is output to a laser unit.

The visible image forming section of the image forming section 12 executes an image forming process to form a toner image corresponding to the image signal output from the CCD onto the sheet.

An image forming section 12 (not shown) includes, for example, an image carrier with an organic photoconductor OPC at the surface thereof, a corona charger for uniformly charging the image carrier, a laser unit for forming an electrostatic latent image on the image carrier, a developing device including a developing roller for supplying a developing agent to the electrostatic latent image on the image carrier to carry out developing, a transfer roller, a cleaner for removing and collecting transfer residual toner and the like, and a charge removing lamp for removing electric charge on the image carrier after transfer.

The image carrier includes the organic photoconductor OPC at the surface thereof, and is rotated at a circumferential speed of, for example, 136 mm/sec. The corona charger, the laser unit, the developing device, the transfer roller, the cleaner and the charge removing lamp are arranged in order along the rotational direction of the image carrier around the image carrier.

The corona charger which is, for example, a scorotron-type corona charger carries out uniform charging of negative polarity on the image carrier. Scanning exposure of laser light is carried out on the uniformly charged image carrier at a resolution of 600 dpi by a laser (semiconductor laser) loaded in the laser unit according to the image signal obtained by the scanner, and the electrostatic latent image is formed on the image carrier.

The developing device houses, for example, powder toner, and the developing device develops the electrostatic latent image on the image carrier to form the toner image.

The printing section 14 is a unit that heats the foregoing toner image and transfers the toner image onto the sheet. The printing section 14 includes a transfer roller and a pressure roller facing this transfer roller across the sheet.

The transfer roller, which is a conductive roller, is applied with a transfer bias voltage of positive polarity from a high-voltage power supply. The toner image formed on the image carrier is transferred onto the conveyed sheet by the transfer roller to which the transfer bias is applied. The sheet on which the toner image is transferred and fixed is discharged to the outside of the image forming apparatus 10 using the sheet discharge section 15.

Furthermore, the cleaner includes a cleaning blade that contacts the surface of the image carrier and scrapes off the toner left on the image carrier after the image transfer to the sheet. The charge removing lamp removes the electric charge left on the surface of the image carrier. The image carrier, from which the electric charge has been removed, is used for the formation of the next electrostatic latent image.

The toner image formed in the image forming section 12 as stated above is transferred onto the sheet and fixed on the sheet through heating the sheet and toner in the printing section 14. On the other hand, an analog image signal obtained in the image forming apparatus 12 is converted to a digital image signal in the AD conversion section 16 and sent to the data storage section 18.

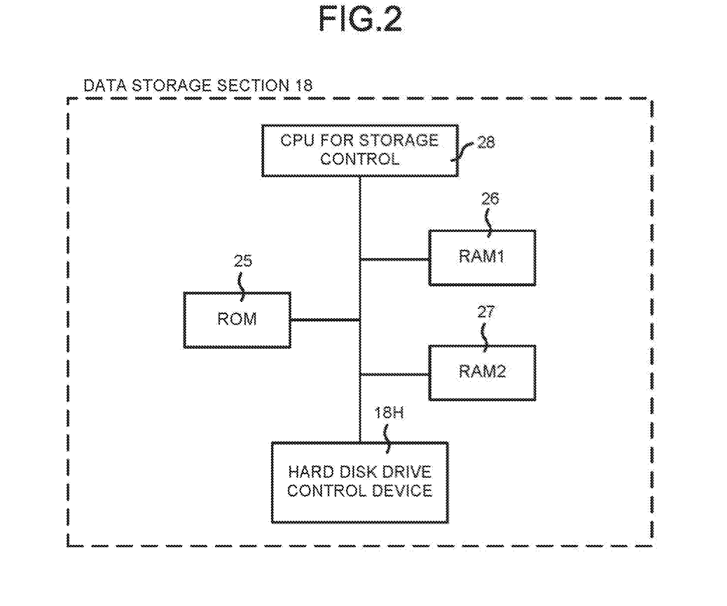

An example of the configuration of the data storage section 18 is illustrated in FIG. 2. The data storage section 18 includes the hard disk drive control device 18H described later, a ROM (Read Only Memory) 25 which stores a variety of data in advance, a RAM (Random Access Memory) 1 and a RAM 2 which carry out storage and reading of a variety of data as necessary, and a control processing unit (CPU) for storage control 26 which controls storage and reading of the data of these storage devices.

A large amount of digital data is stored in the hard disk drive control device 18H; however, the RAM 1 or the RAM 2 is used to smoothly carry out the storage and reading of a small amount of digital data to the hard disk drive control device 18H.

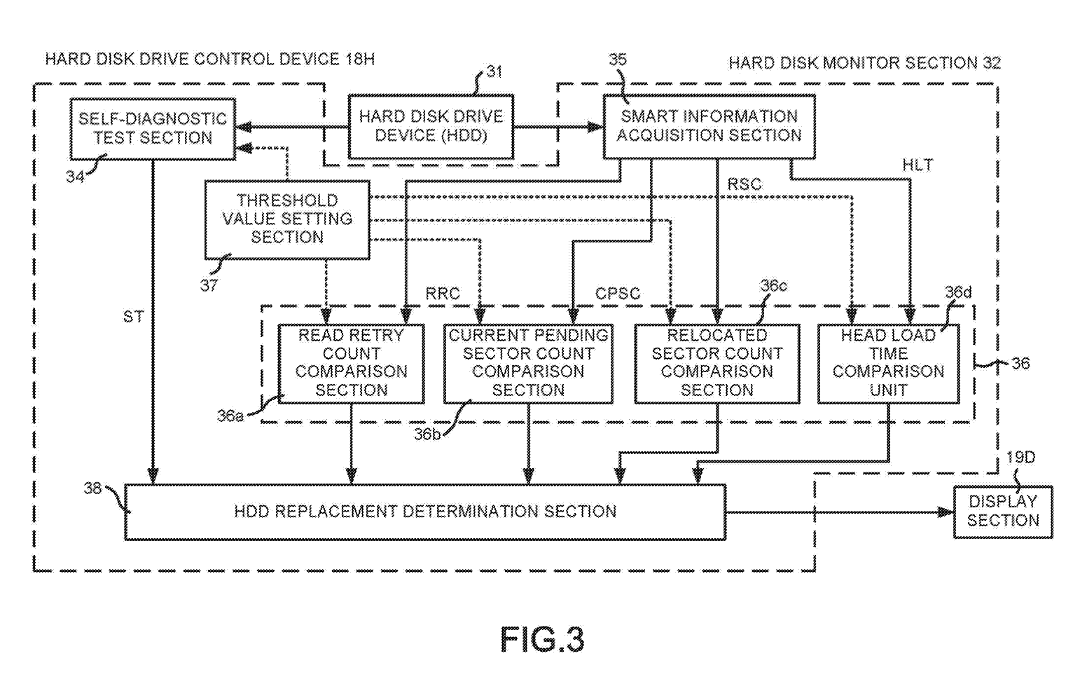

An example of the configuration of the hard disk drive control device 18H is illustrated in FIG. 3. The hard disk drive control device 18H is roughly composed of a conventionally known hard disk drive device (HDD) 31, and a hard disk monitoring section 32 which monitors the state of the hard disk drive device and determines whether the stored data needs to be stored in a back-up storage or whether it is time to replace the HDD. The HDD 31 is composed of a hard disk and a mechanism for rotating the hard disk.

The hard disk monitoring section 32 includes a self-diagnostic test section 34, a failure determination information acquisition section 35, a parameter comparison section 36 for comparing four parameters of failure determination information described later with predetermined values, a threshold value setting section 37 for setting a threshold value of each parameter, and an HDD replacement determination section 38 for determining whether the HDD should be replaced or the data should be backed up according to a result of the parameter comparison section 36.

The HDD replacement determination section 38 displays the result of a determination on the display section 19D.

The parameter comparison section 36 includes a read retry count comparison section 36a, an operation sector count comparison section 36b, a relocated sector count comparison section 36c, and a head load time comparison section 36d.

Incidentally, in the embodiment, two types of failure predictions are carried out on the basis of information of operation states of the HDD 31. One type refers to failure prediction by the self-diagnostic test section 34, and the other type refers to failure prediction based on the failure determination information obtained by the failure determination information acquisition section 35. The two types of failure prediction can both detect a current failure by observing whether or not a parameter serving as an index of each failure prediction exceeds a threshold value, in other words, by comparing the two values (the failure parameter and the threshold value), and determining whether or not the HDD should be replaced on the basis of the comparison. Each type determines a failure parameter, and the comparison circuit compares the failure parameter of each type to a setting-changeable threshold value to detect a failure.

The failure determination information herein uses four parameters.

The self-diagnostic test section 34, for example, sends a diagnostic command to the HDD to start diagnosis, and obtains a diagnostic result. Diagnostic tests include a standard self-test, a short self-test and an expanded self-test. Specifically, the diagnostic tests include a write head test, a seek test, and a read throughput test.

Further, as a method of reporting that a failure prediction threshold has been exceeded, a predetermined parameter, which may be identified by the manufacturer, of HDD components such as a hard disk which is operating in the HDD may be compared to a threshold value set by the manufacturer according to the manufacturer's standards, and failure prediction may be reported when a value of the predetermined parameter is larger than the threshold value.

The threshold value setting section 37 sets the threshold value of a selected parameter of the self-diagnostic test section 34. The threshold value setting section 37 sets an initial value in advance, and the operator can change the value.

The self-diagnostic test section 34 outputs a self-diagnostic result signal ST. The self-diagnostic result signal ST is one of NO or OK resulting from the self-diagnostic test, based on whether or not the parameter value exceeds the threshold value provided by the threshold value setting section 37.

Further, the threshold value setting section 37 outputs each threshold value to each of the read retry count comparison section 36a, the operation sector count comparison section 36b, the relocated sector count comparison section 36c and the head load time comparison section 36d in the HDD 31. The initial values of these threshold values are set in advance, and the operator can change the values.

The failure determination information acquisition section 35 outputs read retry count RRC information of the HDD 31 to the read retry count comparison section 36a. The read retry count RRC is a count of the number of read/write attempts until reading and writing are successful. The failure determination information acquisition section 35 outputs current pending sector count CPSC information to the current pending sector count comparison section 36b. The current pending sector count CPSC refers to the count of sectors which cannot be written and read currently.

The failure determination information acquisition section 35 outputs relocated sector count RSC information of the HDD 31 to the relocated sector count RSC comparison section 36c. The relocated sector count RSC refers to a count of new sectors, referred to as relocated sectors, defined to replace sectors for which writing and reading cannot be carried out.

The failure determination information acquisition section 35 outputs head load time HLT information of the HDD 31 to the head load time comparison section 36d. The head load time HLT refers to accumulated reading and writing time of the magnetic head.

As stated above, threshold value TLs of the read retry count RRC, the current pending sector count CPSC, the relocated sector count RSC and the head load time HLT are input respectively to the read retry count comparison section 36a, the current pending sector count comparison section 36b, the relocated sector count comparison section 36c and the head load time comparison section 36d. The threshold value of each item is represented in parentheses after the denotation “TL”. For example, the initial value of the read retry count is represented as TL (RRC). Other information relating to the HDD is represented similarly.

The HDD replacement determination section 38 receives the self-diagnostic result signal ST output from the self-diagnostic test section 34 and the output signals of the four comparison sections 36a, 36b, 36c and 36d to determine whether the HDD should be replaced (category 1: CG1) or the data should be backed up (category 2: CG2).

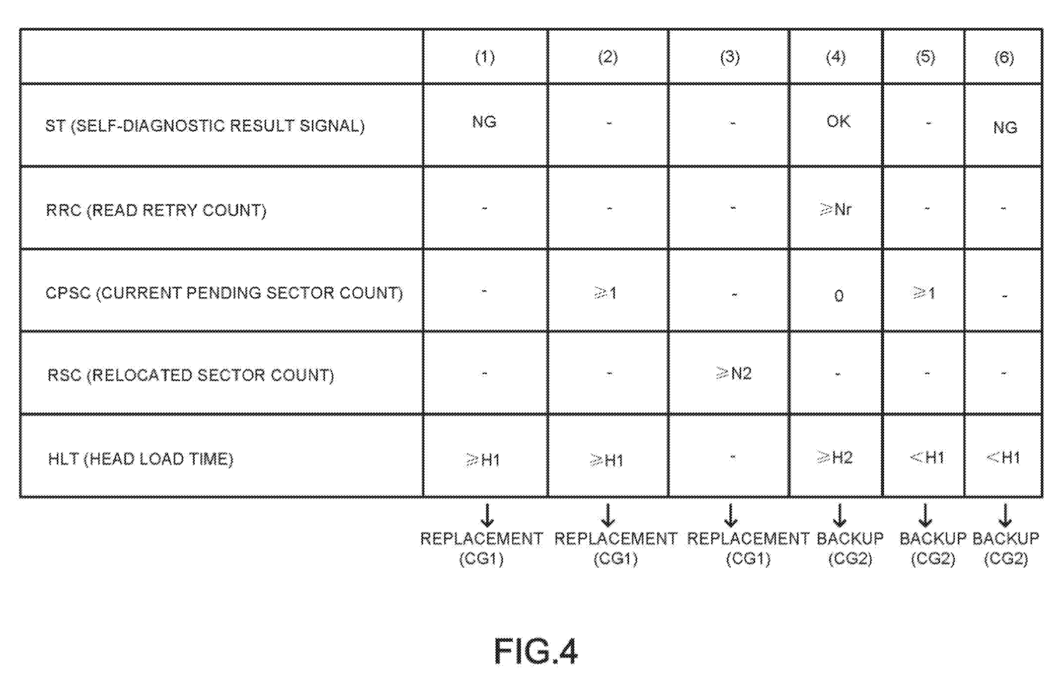

A logical table indicating conditions used by the HDD replacement determination section 38 is shown in FIG. 4 . In FIG. 4, columns (1)˜(6) indicate six conditions 1-6, and “-” indicates unconditionality. In the table shown in FIG. 4, the threshold value of the read retry count RRC is represented as Nr, and for example, the initial value may be 10. The threshold value of the current pending sector count CPSC is, for example, 1. The threshold value of the relocated sector count RSC is represented as N2, and the initial value is, for example, 2000*8, that is, 16000. The threshold values of the head load time HLT are represented as H1 and H2, and the individual initial value is, for example, 4000 hours. These initial values can be changed by the operator. “Unconditionality” means that the entry in the table indicated by “-” may be any value, or no value, to resolve the determination at the bottom of respective columns (1)-(6).

In FIG. 4, for example, if the self-diagnostic result signal ST output from the self-diagnostic test section 34 is NG (“no-good”) and the head load time HLT of the head load time comparison section 36d output is equal to or greater than the threshold value H1, the condition of column (1) is established. In other words, the condition (1) exists when the various values meet the criteria of category 1. Under such circumstances, the HDD replacement determination section 38 determines that it is time to replace the HDD 31, as shown at the bottom of column (1) in FIG. 4. The result determined by the HDD replacement determination section 38 is output as an HDD replacement signal and displayed on a display surface of the display section 19D. In a case where the value of ST and the value of HLT satisfy condition (1), the value of RRC, CPSC, RSC do not affect the determination of condition (1).

If the current pending sector count (CPSC) is equal to or greater than 1 and the head load time HLT is equal to or greater than H1 hours, then condition (2) is established. Condition (2) is a category 1 condition, so the HDD replacement determination section 38 determines that the replacement time of the HDD 31 has occurred as shown at the bottom of column (2) of FIG. 4, and displays this message on the display section 19D.

Further, when the relocated sector count (RSC) is equal to or greater than N2, the condition (3) is established. Condition (3) is a category 1 condition, so the HDD replacement determination section 38 determines that it is time to replace the HDD 31 as shown at the bottom of column (3) in FIG. 4, and displays the message on the display section 19D.

In a case in which the self-diagnostic result signal ST is OK, the read retry count RRC is equal to or greater than Nr, and the head load time HLT is equal to or greater than H2, condition (4) is established. Condition (4) is a category 2 condition, so the HDD replacement determination section 38 determines that the data of the HDD 31 should be backed up as shown at the bottom of column (4) in FIG. 4, and displays this message on the display section 19D.

In a case in which the current pending sector count CPSC is equal to or greater than 1 and the head load time HLT is smaller than H1, the condition (5) is established. Condition (5) is a category 2 condition, so the HDD replacement determination section 38 determines that the data of the HDD 31 should be backed up as shown at the bottom of column (5) in FIG. 4, and displays this message on the display section 19D.

Furthermore, in a case in which the self-diagnostic result signal ST is NG and the head load time HLT is smaller than H1, the condition (6) is established. Condition (6) is a category 2 condition, so the HDD replacement determination section 38 determines that the data of the HDD 31 should be backed up as shown at the bottom of column (6) in FIG. 4, and displays this message on this display section 19D.

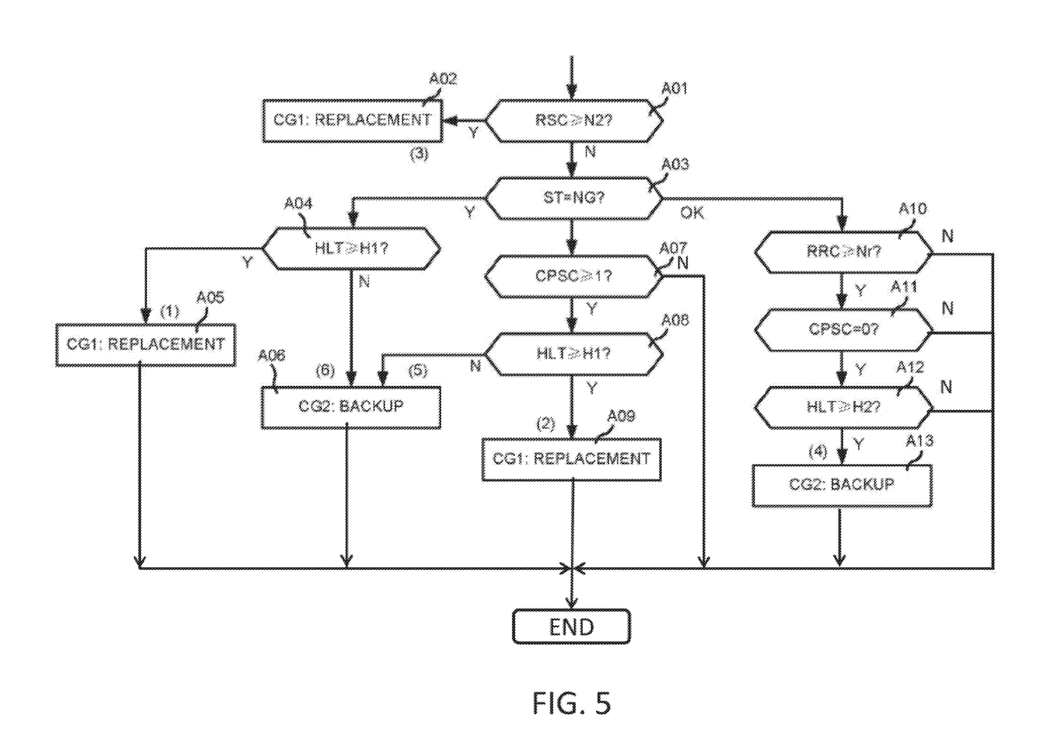

Next, the determination operations to determine the need to replace the HDD 31 (category 1) or backup the data (category 2) represented in FIG. 4 are described with reference to the flowchart shown in FIG. 5.

The self-diagnostic result signal ST output from the self-diagnostic test section 34 shown in FIG. 3 is input to the HDD replacement determination section 38. This signal is either OK which means the self-diagnostic result of the selected HDD internal information of the HDD 31 is normal, or NG which means that there is some abnormality in the HDD.

A comparative result between the read retry count RRC and Nr is input from the read retry count comparison section 36a to the HDD replacement determination section 38. A comparative result indicating that the current pending sector count CPSC is 0 or equal to or greater than 1 is input from the current pending sector count comparison section 36b to the HDD replacement determination section 38.

A comparative result between the relocated sector count RSC and N2 is input from the relocated sector count comparison section 36c to the HDD replacement determination section 38. A comparative result between the head load time HLT and H1 or H2 is input from the head load time comparison section 36d to the HDD replacement determination section 38.

The HDD replacement determination section 38 determines whether or it is time to replace the HDD by performing the following steps at predetermined times.

In FIG. 5, the HDD replacement determination section 38 detects whether or not the relocated sector count RSC is equal to or greater than the predetermined number N2 (Act A01). If the relocated sector count RSC is equal to or greater than the predetermined number N2, the condition (3), which is a category 1 condition, is met, and thus the HDD replacement determination section 38 determines that it is time to replace the HDD 31 (Act A02). In FIG. 5, the condition numbers shown in parentheses correspond to respective columns of FIG. 4.

If the relocated sector count RSC is not equal to or greater than the predetermined number N2, the HDD replacement determination section 38 detects whether or not the self-diagnostic result signal ST of the self-diagnostic test section 34 output is NG (Act A03).

If the self-diagnostic result signal ST is NG, the HDD replacement determination section 38 detects whether or not the head load time HLT is equal to or greater than the first predetermined time H1 (Act A04). If the head load time HLT is equal to or greater than the first predetermined time H1, the condition (1) is met. Thus, the HDD replacement determination section 38 determines that it is time to replace the HDD 31 (A05). This case corresponds to category 1.

If the head load time HLT is shorter than the first predetermined time H1 in the processing in Act A04, the condition (6) is met. Thus, the HDD replacement determination section 38 carries out only the backup of the data without replacing the HDD 31 (A06). This case corresponds to category 2.

If the self-diagnostic result signal ST is not determined(not NG) in the processing in Act A03, the HDD replacement determination section 38 detects whether or not the current pending sector count CPSC is equal to or greater than 1 (Act A07). If the current pending sector count CPSC is equal to or greater than 1 in the processing of Act A07, the HDD replacement determination section 38 detects whether or not the head load time HLT is equal to or greater than the first predetermined time H1 (Act A08). If the head load time HLT is equal to or greater than H1, the condition (2) is met. Thus, the HDD replacement determination section 38 determines that it is time to replace the HDD 31 (Act A09). This case corresponds to the category 1.

If the head load time HLT is shorter than the first predetermined time H1 in the processing in Act A08, the condition (5) is met, and thus the HDD replacement determination section 38 proceeds to the processing in Act A06 to determine that the data stored on HDD 31 should be backed up.

If the self-diagnostic result signal ST is OK in the processing in Act A03, the HDD replacement determination section 38 detects whether or not the read retry count RRC is equal to or greater than the setting value Nr (Act A10). If the read retry count RRC is equal to or greater than the setting value Nr, the HDD replacement determination section 38 detects whether or not the current pending sector count CPSC is 0 (Act All). If the current pending sector count CPSC is 0, the HDD replacement determination section 38 detects whether or not the head load time HLT is equal to or greater than the second predetermined time H2 (Act A12). If it is detected that the head load time HLT is equal to or greater than the second predetermined time H2, the condition (4) is met. Thus, the HDD replacement determination section 38 determines that the data on HDD 31 should be backed up (Act A13). This case corresponds to the category 2.

As stated above, the result determined by the HDD replacement determination section 38 is displayed on the displayed screen of the display section 19D.

Furthermore, in a case of failing to correspond to any one of the conditions shown in FIG. 4, the HDD replacement determination section 38 waits until the next detection time to determine the status of the HDD. In a case corresponding to any one of the conditions shown in FIG. 4, the HDD replacement determination section 38 carries out the replacement of the HDD or the backup of the data.

In the image forming apparatus 10 shown in FIG. 1, if it is time to replace the HDD 31, a message may be displayed on the display section 19D. However, it is also possible that if it is time to replace the HDD, the HDD replacement determination section 38 may alternatively, or concurrently, send a message to an external device via the communication interface 17.

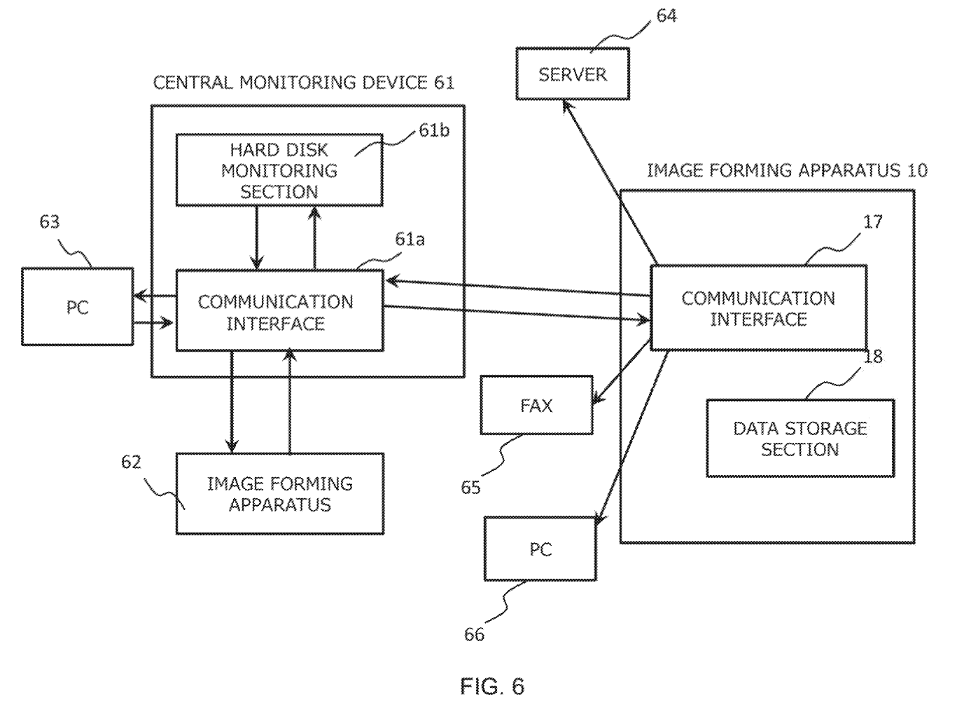

An example of the configuration of such a whole system is shown in FIG. 6. In FIG. 6, HDD replacement information from the communication interface section 17 of the image forming apparatus 10 is sent to a central monitoring device 61. The central monitoring device 61 includes a communication interface section 61a and a hard disk monitoring section 61b.

The HDD replacement information which is sent from the image forming apparatus 10 in a wired or wireless manner is received by the communication interface section 61a. The HDD replacement information includes information indicating whether the HDD should be replaced or whether the data on the HDD should be backed up. In the hard disk monitoring section 61b, a maintenance worker observes the HDD replacement information from the image forming apparatus 10 to determine whether or not it is time for the HDD to be replaced. If the maintenance worker observes the information indicating only the backup of the data, it is possible to carryout a backup instruction to the image forming apparatus 10 from the hard disk monitoring section 61b via the communication interface sections 61a and 17.

The central monitoring device 61 is also connected to another image forming apparatus 62 and a personal computer 63 in a wired or wireless manner. The central monitoring device 61 can acquire the HDD replacement information from these apparatuses to collectively monitor the states of the HDDs of respective apparatuses.

The HDD replacement information of the image forming apparatus 10 can also be sent to external devices including a server 64, a facsimile device 65, a personal computer 66 and the like from the communication interface section 17, so that the determination whether to replace the HDD of the image forming apparatus 10 can be made in these external devices.

In the foregoing embodiment, the replacement of the HDD is carried out in a case corresponding to category 1, and the backup of the data is carried out in a case of corresponding to category 2. In this manner, if the execution of not only the replacement of the HDD but also the backup is instructed, it is possible to provide a high-reliability HDD.

However, in the present embodiment, it is also possible that only the replacement of the HDD is carried out in a case of corresponding to category 1, without carrying out the backup of the data in a case of corresponding to category 2.

Furthermore, the embodiment may be alternatively configured as set forth below. The HDD replacement determination section 38 may determine the value of ST, RRC, CPSC, RSC and HLT, and the condition of the HDD without performing the actions in FIG. 5. The HDD replacement determination section 38 may determine that it is time to replace the HDD in a case where one of conditions (1), (2) or (3) set forth below is satisfied. And then the determined result is displayed on the display section 19D.

(1) Self diagnostic result signal ST=NG and head load time HLT is equal to or greater than H1

(2) Current pending sector count CPSC is equal to or greater than 1 and head load time HLT is equal to or greater than H1

(3) Relocated sector count is equal to or greater than N2 Furthermore, the HDD replacement determination section 38 may determine that backup of the data is sufficient in a case where one of the following conditions (4), (5) or (6) is satisfied.

(4) Self diagnostic result signal ST=OK, Read retry count RRC is equal to or greater than Nr, current pending sector count CPSC is 0, and head load time HLT is equal to or greater than H2.

(5) Current pending sector count CPSC is equal to or greater than 1 and head load time HLT is less than H1

(6) Self diagnostic result signal ST=OK and head load time HLT is less than H1.

In the foregoing embodiment, the process, the functions and determinations of the self-diagnostic test section and the failure determination information acquisition section, and the comparison of their information, are described by reference to blocks in a flowchart, but may be performed by software.

The present embodiment can be generally applied to an apparatus using a hard disk drive device (HDD), for example, a computer. Further, in the foregoing embodiment, a device having a HDD within an image forming apparatus is described; however, the present embodiment can also be applied to a case of using an HDD external to the image forming apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information processing apparatus, comprising:
a hard disk drive device; and
a controller configured to:
carry out a self-diagnostic test regarding operation states of the hard disk drive device,
output result information of the self-diagnostic test,
acquire failure determination information of the hard disk drive device which is different from the result information, and
determine whether it is time to replace the hard disk drive device based on the failure determination information and the result information of the self-diagnostic test.

2. The information processing apparatus according to claim 1, wherein the failure determination information includes a relocated sector count, and
the controller is configured to determine that is it time to replace the hard disk drive device in a case in which the relocated sector count is equal to or greater than a predetermined number.

3. The information processing apparatus according to claim 1, wherein the failure determination information includes a current pending sector count and a head load time, and
the controller is configured to determine that it is time to replace the hard disk drive device in a case in which the current pending sector count is equal to or greater than a predetermined value, and the head load time is equal to or greater than a predetermined time.

4. The information processing apparatus according to claim 1, wherein the failure determination information includes a read retry count and a head load time, and
the controller is configured to carry out backup of data in a case in which the result information is good, the read retry count is equal to or greater than a predetermined count, and the head load time is equal to or greater than a predetermined time.

5. The information processing apparatus according to claim 1, wherein the failure determination information includes a head load time, and
the controller is configured to determine whether it is time to replace the hard disk drive device or whether to carry out the backup of the data based on the head load time in a case in which the result information is no good.

6. The information processing apparatus according to claim 5, wherein the controller is configured to determine that it is time to replace the hard disk drive device in a case in which the head load time is equal to or greater than a predetermined time.

7. The information processing apparatus according to claim 5, wherein the controller is configured to carry out the backup of data in a case in which the head load time is less than a predetermined time.

8. An image forming apparatus, comprising:
a document scanning section;
a printing section configured to print scanning data obtained by scanning a document using the document scanning section on a sheet;
a communication interface configured to send data to, and receive data from, an external communication device;
a hard disk drive device; and
a controller configured to;
carry out a self-diagnostic test regarding the operation states of the hard disk drive device,
output result information of the self-diagnostic test,
acquire failure determination information of the hard disk drive device which is different from the result information, and
determine whether or not it is time to replace the hard disk drive device based on the failure determination information and the result information of the self-diagnostic test.

9. The image forming apparatus according to claim 8, wherein the failure determination information includes a relocated sector count, and
the controller is configured to determine that it is time to replace the hard disk drive device in a case in which the relocated sector count is equal to or greater than a predetermined number.

10. The image forming apparatus according to claim 8, wherein the failure determination information includes a current pending sector count and a head load time, and
the controller is configured to determine that it is time to replace the hard disk drive device in a case in which the current pending sector count is equal to or greater than a predetermined value, and the head load time is equal to or greater than a predetermined time.

11. The image forming apparatus according to claim 8, wherein the failure determination information includes a read retry count and a head load time, and
the controller is configured to carry out backup of data in a case in which the result information is good, the read retry count is equal to or greater than a predetermined count and the head load time is equal to or greater than a predetermined time.

12. The image forming apparatus according to claim 8, wherein the failure determination information includes a head load time, and
the controller is configured to determine whether it is time to replace the hard disk drive device or whether to carry out backup of the data based on the head load time in a case in which the result information is no good.

13. The image forming apparatus according to claim 12, wherein the controller is configured to determine that it is time to replace the hard disk drive device in a case in which the head load time is equal to or greater than a predetermined time.

14. The information processing apparatus according to claim 12, wherein the controller is configured to carry out the backup of data in a case in which the head load time is less than a predetermined time.

15. An information processing apparatus, comprising:
a hard disk drive device;
a self-diagnostic test section configured to carry out a self-diagnostic test regarding the operation states of the hard disk drive device and output result information of the self-diagnostic test;
a failure determination information acquisition section configured to acquire failure determination information of the hard disk drive device which is different from the result information; and
a hard disk replacement determination section configured to determine whether or not it is time to replace the hard disk drive device based on the failure determination information output by the failure determination information acquisition section and the result information of the self-diagnostic test.

16. The information processing apparatus according to claim 15, wherein
the failure determination information includes a relocated sector count, and in a case in which the relocated sector count is equal to or greater than a predetermined number, the hard disk replacement determination section determines that it is time to replace the hard disk drive device.

17. The information processing apparatus according to claim 15, wherein
the failure determination information includes the current pending sector count and the head load time, and
in a case in which the current pending sector count is equal to or greater than a predetermined value and the head load time is equal to or greater than a predetermined time, the hard disk drive replacement determination section determines that it is time to replace the hard disk drive device.

18. The information processing apparatus according to claim 15, wherein
the failure determination information includes a read retry count and a head load time, and
in a case in which the self-diagnostic result signal is good, the read retry count is equal to or greater than a predetermined count, and the head load time is equal to or greater than a predetermined time, the hard disk replacement determination section carries out backup of data.

19. The information processing apparatus according to claim 15, wherein
the failure determination information includes a head load time, and
the hard disk replacement determination section is configured to determine whether it is time to replace the hard disk drive device or whether to carry out the backup of the data based on the head load time in a case in which the result information is no good.

20. The information processing apparatus according to claim 19, wherein
in a case in which the head load time is equal to or greater than a predetermined time, and in a case in which the result information is NG, the hard disk replacement determination section is configured to determine that it is time to replace the hard disk drive device.
